(19) United States
(12) Patent Application Publication
(10) Pub. No.: US 2018/0060449 A1
(43) Pub. Date: Mar. 1, 2018

(54) WEARABLE DEVICES WITH SEARCHABLE DATA

(71) Applicant: KONINKLIJKE PHILIPS N.V., EINDHOVEN (NL)

(72) Inventors: JOHN CRONIN, BONITA SPRINGS, FL (US); JOSEPH BODKIN, WILLISTON, VT (US)

(73) Assignee: AKONINKLIJKE PHILIPS N.V.

(21) Appl. No.: 15/556,322

(22) PCT Filed: Mar. 9, 2016
(86) PCT No.: PCT/IB2016/051315

§ 371 Date: Sep. 7, 2017

Related U.S. Application Data
(60) Provisional application No. 62/130,131, filed on Mar. 9, 2015.

(51) Int. Cl. G06F 17/30; G06F 19/00

(52) U.S. Cl. CPC G06F 17/30991; G06F 19/3418; G06F 19/3443; G06F 19/3406

(57) ABSTRACT

In one embodiment, an apparatus (202, 204, 206) for enabling a user-defined search for information in a wearable device data database (220) that resides in a wearable device (202), a user device (204), or a network device (206). The user creates search terms at the time of entry corresponding to wearable device data and an associated context and search results based on the search terms are presented that are customized for the user according to the entered context.

### CROSS REFERENCE TO RELATED APPLICATION

This application claims the benefit of priority of U.S. Provisional Patent Application Ser. No. 62/130,131, filed on Mar. 9, 2015, and titled “WEARABLE DEVICES WITH SEARCHABLE DATA,” which is incorporated by reference herein in its entirety.

### FIELD OF THE INVENTION

The present invention generally relates to the field of wearable devices.

### BACKGROUND OF THE INVENTION

Some current-generation wearable technology devices, such as smartwatches, fitness bands, and health wearables, include one or more sensors for measuring various conditions or states of the wearer. Such sensors may include pulse sensors for measuring the wearer's pulse, temperature sensors for measuring the wearer's temperature, and/or accelerometers for measuring the wearer's movement. However, information derived from such sensors is typically extremely difficult for a user to meaningfully digest. Consequently, users of current-generation wearable technology devices are limited in the number of ways they can make use of information derived from one or more wearable sensors. For instance, the Apple® phone has an Apple Health application (information about which may be found at the website entitled, “How to use Apple Health on your iPhone: Everything You need to Know, and found at http://www.wareable.com/apps/how-to-use-apple-health-iphone-fitness-app-960), which, through the use of the dashboard function, may be used to access activity data, including steps, calories burned, distance, flight of stairs climbed, etc. Predefined blocks or icons presented on a graphical user interface of the phone enables the user to select, for instance, active calories for a day, week, or month.

### SUMMARY OF THE INVENTION

One object of the present invention is that data of a wearable device database can be searched based on plural search terms corresponding to the data and a context are entered at a user interface and created by the user at the time of entry.

Another object of the present invention is that search results are customized for the user based on the entered context. In one embodiment of the invention, an apparatus for enabling a user-invoked term search for information in a wearable device data database that resides in a wearable device, a user device, or a network device.

To better address such concerns, in a first aspect of the invention, an apparatus for enabling a user-defined search for information in a wearable device data database that resides in a wearable device, a user device, or a network device. The user creates search terms at the time of entry corresponding to wearable device data and an associated context and search results based on the search terms are presented that are customized for the user according to the entered context. The present invention addresses a problem in the art of devices that present pre-defined icons for a user to enable a search of wearable device data by enabling the user to create the search terms he or she feels will provide the desired information and providing search results that are customized according to the context the user has decided to enter.

In one embodiment, the one or more second terms comprise one or any combination of a comment, tag, or a metric, associating user activity or behavior and the data. By enabling the user to create the context search, a wide variety of information may be obtained beyond that intended by the manufacturer.

In one embodiment, the metric comprises any one of the following: daily percentages, monthly percentages, yearly percentages, daily totals, monthly totals, or yearly totals. These, and other metrics, enable the user (or third party developer) to gather information from different perspectives.

In one embodiment, the apparatus is further configured to execute the search by parsing the plural search terms and identifying one or more associated programs based on the parsing. By doing so, relevant search results may be obtained.

In one embodiment, the apparatus is configured to provide the search results by visually or aurally presenting the search results at a wearable device. By providing the search results at the wearable device, the user need not access a user device or network device, enabling receipt of information quickly and conveniently.

In one embodiment, the apparatus is configured to present the search results visually or aurally exclusive of information corresponding to wearable device data that is not based on the plural search terms. For instance, the search results are presented based only on the data and context requested by the user, unencumbered by additional wearable device data such as in user interfaces presenting predefined charts or information comprising an overload of all sorts of wearable device data.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views. In certain instances, details that are not necessary for an understanding of the embodiments or that render other details difficult to perceive may have been omitted.

FIG. 1 is a flow diagram that illustrates a method of enabling searching of wearable device data in accordance with an embodiment of the invention.

FIG. 2 is a schematic diagram that illustrates an example system that can be used to implement wearable devices with searchable data in accordance with an embodiment of the invention.

FIGS. 3A-B are schematic diagram that illustrate examples of portions of a user interface that may correspond to a wearable device interface, a search network interface, or a user device interface in accordance with an embodiment of the invention.

FIGS. 4A-C are schematic diagram that illustrate examples of various searches that can be executed in accordance with an embodiment of the invention.

FIGS. 5A and 5B are schematic diagrams that illustrate two examples of searches being parsed out into different terms in accordance with an embodiment of the invention.

FIG. 6 is a block diagram that illustrate an example computing device that may implement various ones of the features and processes of the present disclosure in accordance with an embodiment of the invention.

FIGS. 7A-7C are flow diagrams that illustrate examples of high-level software methods that may be executed by one or more devices of the system of FIG. 2 in accordance with an embodiment of the invention.

FIG. 8 is a flow diagram that illustrates an example method implemented by example wearable device base software in accordance with an embodiment of the invention.

FIG. 9 is a schematic diagram that illustrates an example of a wearable device data database in accordance with an embodiment of the invention.

FIG. 10 is a schematic diagram that illustrates an example of a search database that may be stored in a wearable device, user device, and/or a search network in accordance with an embodiment of the invention.

FIG. 11 is a flow diagram that illustrates an example method implemented by search software that may be stored on a wearable device, a user device, and/or a search network in accordance with an embodiment of the invention.

FIG. 12 is a flow diagram that illustrates an example method implemented by user device base software in accordance with an embodiment of the invention.

FIG. 13 is a flow diagram that illustrates an example method implemented by search network base software in accordance with an embodiment of the invention.

FIG. 14 is a flow diagram that illustrates an example method that can be used to implement wearable devices with searchable data in accordance with an embodiment of the invention.

FIG. 15 is a block diagram of a computing system that can be used to implement any one or more of the methodologies disclosed herein and any one or more portions thereof in accordance with an embodiment of the invention.

### DETAILED DESCRIPTION OF EMBODIMENTS

Disclosed herein are certain embodiments of an apparatus, system, method, and non-transitory computer-readable storage medium that enable a user to create and enter one or more search terms to find particular pieces of data according to a context (e.g., metrics, such as averages, percentages, totals, comments/tags, etc.) and/or other analytical information that are sourced from, or can be derived from, wearable device data. This functionality enables users and/or third party software developers to filter information derived from wearable sensor data in meaningful ways such that they can use the information in new ways. For example, by using aspects of the present disclosure, users can analyze information derived from wearable sensors and use the knowledge they glean from that analysis in order to, e.g., optimize their workouts and/or health information or monitor their progress towards achieving one or more exercise and/or health goals.

Digressing briefly, it is recognized that although wearable devices can be used to generate large amounts of data for a user, such data can overwhelm the user. Also, the data available may be limiting as to future advances. In contrast, certain embodiments as disclosed herein are directed to an apparatus, system, method, etc. for searching information on a wearable or related device to process the data by other means than a manufacturer may have originally intended. The information may be raw data sourced from wearable sensors of a wearable device or data derived from the raw data. At a high level, aspects of the present disclosure are directed to systems, methods, and software for implementing wearable devices with user-defined, searchable data. By searching a wearable device data database, among other benefits, the consequent customized search results enable a user or third party developer to analyze and process the data to achieve different results and/or draw different conclusions than those dictated by the algorithmic scheme of the manufacturer of the wearable device. In some aspects, the present disclosure is directed to allowing a user to perform a contextual search on a wearable device of data gleaned from two or more sensors of a wearable device.

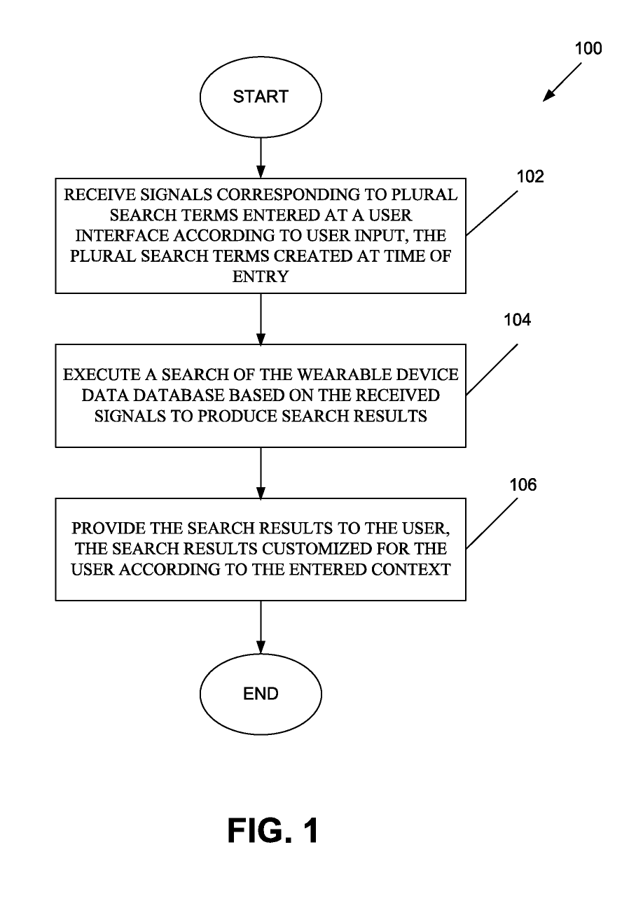

FIG. 1 is a flow diagram that illustrates a method 100 of enabling searching of wearable device data in accordance with an embodiment of the invention. In one embodiment, the method 100 comprises receiving signals corresponding to plural search terms entered at a user interface according to user input, the plural search terms created by the user at the time of entry and comprising a first term associated with data of a wearable device data database that is associated with wearable sensors for a user and one or more second terms associated with a context for the data (102); executing a search of the wearable device data database based on the received signals to produce search results (104); and providing the search results to the user, the search results customized according to the entered context (106). With regard to (102), the first term may comprise a physiological or behavioral parameter associated with the data. For instance, the physiological parameter may comprise any one of the following: blood pressure, accelerometer information, pulse, temperature, steps taken, or calories. Other physiological or behavioral parameters may be searched. The one or more second terms may comprise a context for the search, including tags or comments associating the user activity or behavior with the data and/or a metric associating the user activity or behavior and the data. For instance, the metric may comprise any one of the following: daily percentages, monthly percentages, yearly percentages, daily totals, monthly totals, yearly totals. Also, the metric may include a comparison to a datum, such as a daily percentage for heart rate lower than normal levels or typical levels of a user. The tags or comments may have been entered by the user at the time of participating in the activity (e.g., via entry at the user interface of the wearable device) or while reviewing performance metrics on the wearable device (or other associated devices). The tags or comments may be associated with a specific time (e.g., time stamp) or a range of times or period(s). The signals are those received from a user interface based on input at the user interface by a user. The user input may comprise verbal or manual input (e.g., a touch-screen display, keypad or keyboard, buttons, etc. associated with or without a presented graphical user interface (GUI)). In one embodiment, the user interface may be at a wearable device. In one embodiment, the user interface may be at a user device (e.g., smartphone, personal digital assistant, etc.) or a network device that is remote from the wearable device. The wearable device data may comprise raw data from wearable sensors and/or any information derived therefrom. For example, wearable device data may comprise raw accelerometer data from a pedometer and/or an estimated number of steps derived from such data. In some embodiments, the search terms may be associated with differing types or sources of wearable device data, and the search terms may be received via a graphical user interface, through an application programming interface, or by any other appropriate means.

With regard to (104), the execution of the search is a function of the one or more search terms to produce search results, and may comprise parsing the search terms and/or comparing the search terms to the wearable device data.

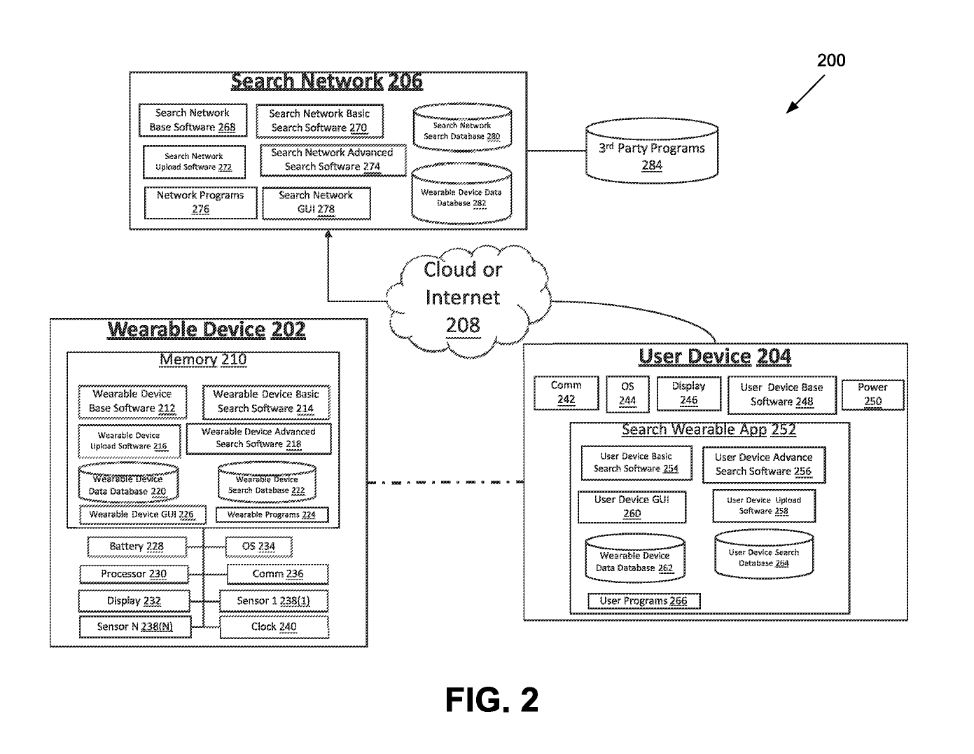

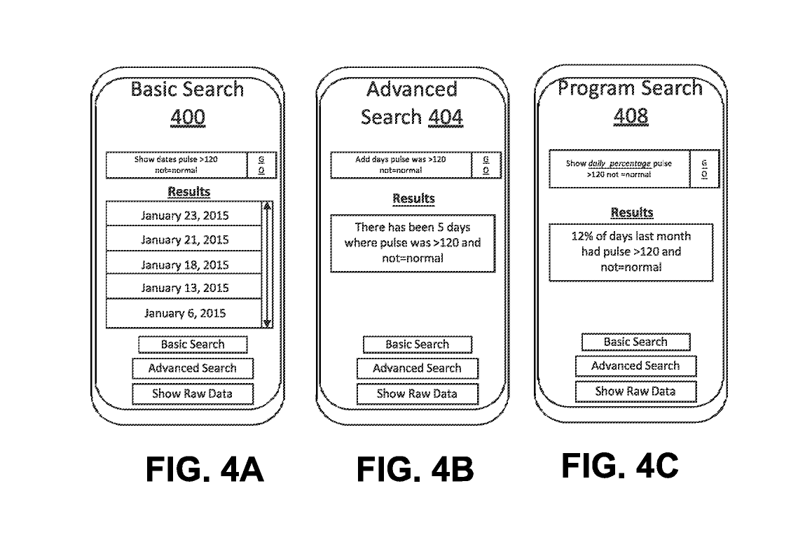

With regard to (106), the search results may be provided to the user by visually displaying the results on a display device (e.g., display screen) and/or aurally presenting the results (e.g., via a speaker or coupled headset), transmitting the results to the user in a text message and/or e-mail, and/or storing the results in a file that the user can access at a later time, among others. In some embodiments, the search results may be presented via tactile feedback (e.g., via electronic Braille or other non-verbal representations of the search). An example of the customization of the search results by context is shown in, and described in association with, FIG. 4A-4C. By using a system like that of FIG. 2 to implement the method 100, users can quickly and easily search wearable device data.

FIG. 2 is a schematic diagram that illustrates an example system 200 that can be used to implement wearable devices with searchable data in accordance with an embodiment of the invention. As shown, the system 200 may include a wearable device 202, a user device 204, and a search network device(s) 206 accessible via cloud and/or Internet 208, although the wearable device may be used exclusively in some embodiments. Reference herein will be made to search network device 206 in the singular, with the understanding that plural devices may be used in some embodiments. The wearable device 202 may contain a memory 210 including wearable device base software 212, wearable device basic search software 214, wearable device upload software 216, a wearable device advanced search software 218, a wearable device data database 220, a wearable device search database 222, wearable programs 224, and/or a wearable device GUI 226. The wearable device 202 may also include a battery 228, a processor 230, a display 232, an operating system (OS) 234, a communications interface (COMM) 236 (which may comprise low power Bluetooth, for example, among others), one or more sensors one to N of one or more types 238(1) to 238(N), and a system clock 240.

The user device 204 may include a communications interface 242, which may comprise, for example, Wi-Fi™ or low power Bluetooth™. The user device 204 may further include an OS 244, a display 246, user device base software 248, a power supply 250, and/or a search wearable app 252, among others. The search wearable app 252 may include user device basic search software 254, user device advanced search software 256, user device upload software 258, a user device GUI 260, a wearable device data database 262, a user device search database 264, and/or one or more user programs 266.

As also shown in FIG. 2, the search network device 206 may include search network base software 268, search network basic search software 270, search network upload software 272, search network advanced search software 274, one or more network programs 276, a search network GUI 278, a search network search database 280, and/or a wearable device data database 282, among others. Search network device 206 may further connect to one or more third party programs 284 via a communications interface, application programming interface, among other mechanisms. Note that reference herein to database may include other data structures in addition to or in lieu of a database.

Functionality of the system 200 depends on where the raw data from wearable device 202 (e.g., the wearable device data database) is stored. For example, such data may be stored on wearable device 202, on the user device 204, and/or in search network device 206. Based on the location of such data, a GUI suitable for searching such data can be implemented on the wearable device 202, the user device 204, and/or the search network device 206 (accessible via, e.g., a website). As described further herein, such a GUI may enable a user to search one or more different programs, specify searches based on daily percentages, monthly percentages, monthly totals, and/or yearly totals, among other metrics or contexts, and add, delete, and/or view the programs associated with the GUI. In some embodiments, if a user desires to enter search terms to identify dates on which their pulse was above a certain rate and not normal, search wearable app 252, for example, may parse the different search terms such that “show,” “dates,” and “pulse” may each correspond to separate searches and/or different programs. Accordingly, one or more of “show,” “dates,” and “pulse” may be stored in a device search database. After the search wearable app 252, for example, locates one or more programs corresponding to a search, then it can execute those programs as a function of the wearable device data database to return the appropriate information, i.e., search results.

To generate information that can be searched when, for example, the device data database is stored in wearable device 202, the wearable device 202 may run wearable device routine operations (e.g., reading data from sensors and storing it in the wearable device data database). To search the information, a user may invoke the operations of (e.g., run) the wearable device GUI 226. However, if the device data database is stored on the user device 204, the user device may invoke the operations of (e.g., run) the wearable device routine operations and then the user may invoke/run the user device GUI 260 to perform searches. If the device data database is stored on search network device 206, then the search network device 206 may run the wearable device routine operations (e.g., collect all the sensor readings), store the associated data in the wearable device data database, and communicate with the user device via the cloud and/or the Internet 208. As such, the user may actively or passively invoke/run user device base software 248 to upload data to search network device 206, then the user may use search network GUI 278 to find information, as well as search network base software 268, search network search software, etc.

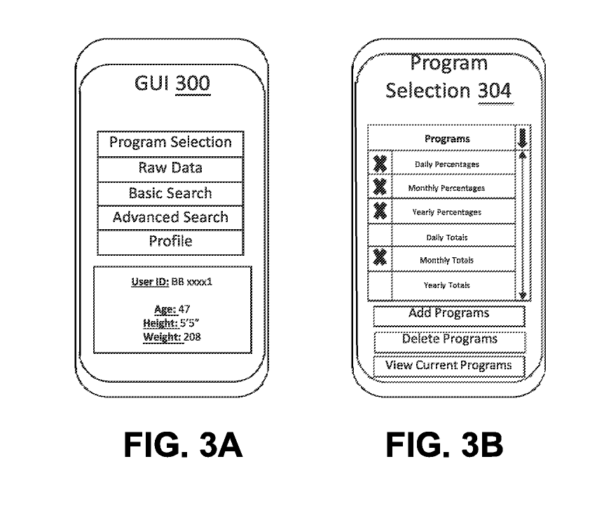

FIGS. 3A-B are schematic diagram that illustrate examples of portions of a user interface that may correspond to a wearable device interface, a search network interface, or a user device interface in accordance with an embodiment of the invention. For instance, FIG. 3A shows examples of portions of a GUI 300 that may correspond to the wearable device GUI 226, a search network GUI 278, and/or a user device GUI 260. FIG. 3A shows a basic outline of the GUI 300, including a program selection option, a raw data viewer, a basic search option for searching the raw data, an advanced search option for searching the raw data, and a profile management option. At the bottom is an example of an optional display showing information related to a currently-loaded profile, such as user ID, age, height, and weight. By selecting the program selection option of the GUI 300 of FIG. 3A, a user may cause the GUI 300 to display a program selection 304 like that of FIG. 3B. By utilizing the program selection, a user can select one or more different programs that they would like to run or keep stored on their device or on a network device. As shown, the program selection includes programs corresponding to such metrics as daily percentages, monthly percentages, yearly percentages, daily totals, monthly totals, and yearly totals. The program selection may further include a scrollbar and/or one or more other selectable programs, and, as shown at the bottom of the program selection, the user can select one or more button icons (or in some embodiments, buttons) to add programs, delete programs, and/or view programs that are currently running.

FIGS. 4A-C are schematic diagrams that illustrate examples of various searches that can be executed in accordance with an embodiment of the invention. That is, FIGS. 4A-C show examples of various searches users can access, for example, by making appropriate selections in GUI 300 of FIG. 3A. FIG. 4A shows a basic search screen 400, in which a user may input user defined search terms (collectively, user input) in the input box at the top of the basic search that are created at the time of entry by the user. Based on the search, the search results show dates the user's pulse was greater than 120 and was not normal. Thus, the search terms include data corresponding to the wearable device sensors (e.g., sensed pulse stored in a wearable device data database) and a context (e.g., dates where the pulse>120 and not normal). Note that in one embodiment, the search terms may be entered according to a natural language search algorithm. By selecting one or more of the buttons icons (or buttons) at the bottom of the basic search screen 400, a user may run another basic search, run a more advanced search, and/or show raw data related to the search results. FIG. 4B shows an advanced search screen 404, in which, for example, a user may enter user-defined/created search terms causing the advanced search to sum the number of days the user's pulse was greater than 120 and not normal. In other words, the inputted search terms include data (the pulse sensed from wearable sensors and stored in a wearable device data database) and the context (a metric, such as the addition, of days the pulse>120 and not normal). FIG. 4C shows a program search screen 408, in which, through this search, a user can search raw data using the programs they have selected in the program selection of FIG. 3. For example, as shown in FIG. 4C, in this case the user requests that the program search show the daily percentage (context) that their pulse (data) was greater than 120 and not normal (context). The daily percentage program may then produce the results shown.

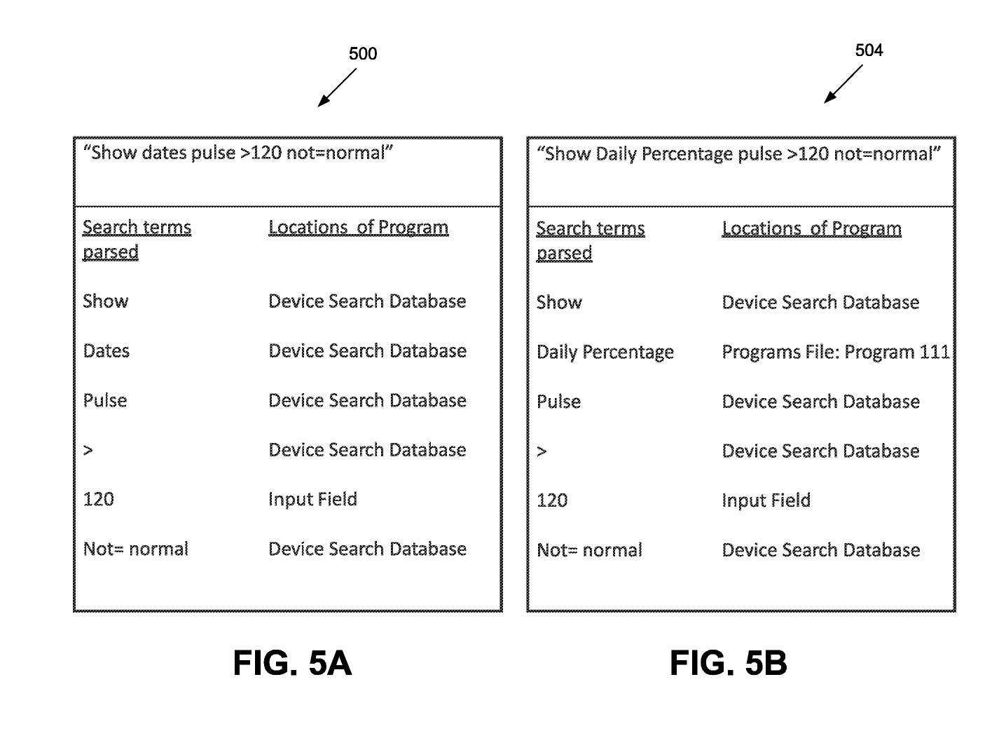

FIGS. 5A and 5B are schematic diagrams that illustrate two examples of searches being parsed out into different terms in accordance with an embodiment of the invention. For instance, the two examples of searches are shown parsed into different terms to show how an appropriate program may be located. In particular, in search parsing example 500 of FIG. 5A, shown is how the search of FIG. 4A may be parsed. In search parsing example 504 of FIG. 5B, shown is how the search of FIG. 4C may be parsed. Starting with parsing example 500 of FIG. 5A, the basic search identifies “show dates,” “pulse greater than 120,” and “not normal,” and so it separates the terms so it searches so that the appropriate program(s) can be located in the device search database. With “dates pulse greater than 120,” the basic search identifies the number “120” as an input field to provide to a program. Turning now to the parsing example 504 of FIG. 5B, the program search for “show daily percentage pulse greater than 120 and not normal” is parsed. As shown, some related programs are located in the device search database; however, the term “daily percentage” runs the program file called “Program 111.”

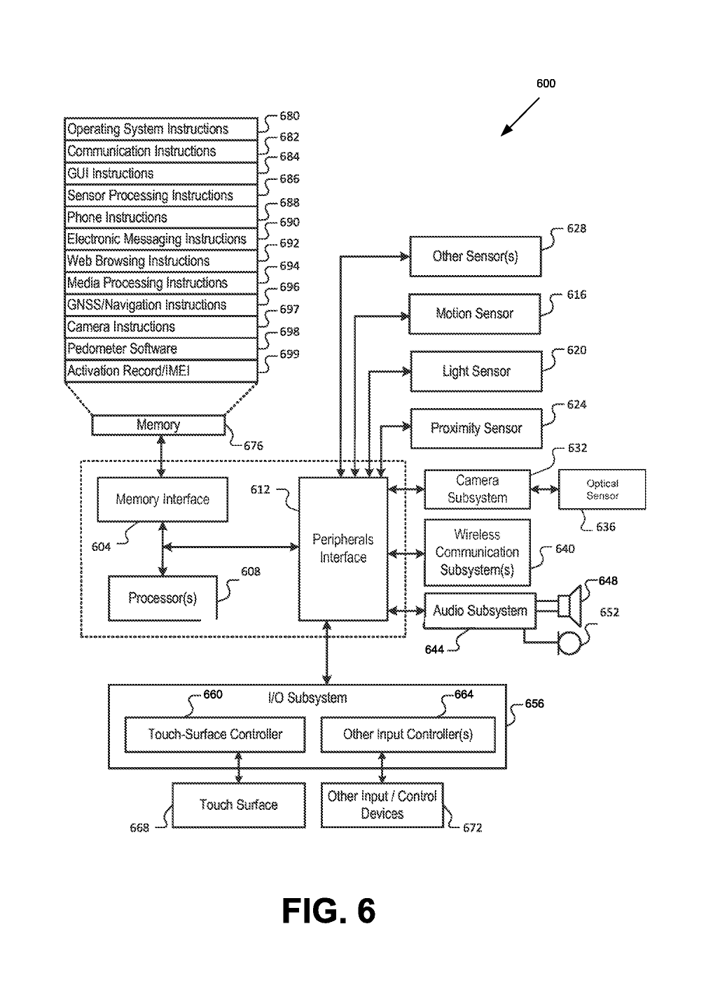

FIG. 6 illustrates an example wearable computing device 600 that may be configured to implement any one or more of various features and/or processes of the present disclosure, such as the features and processes illustrated in other figures of this disclosure, as well as features and processes that would be apparent to those of ordinary skill in the art after reading this entire disclosure. As shown, the computing device 600 may include a memory interface 604, one or more data processors, image processors and/or central processing units 608, and a peripherals interface 612. Memory interface 604, one or more processors 608, and/or peripherals interface 612 may be separate components or may be integrated in one or more integrated circuits. The various components in computing device 600 may be coupled by one or more communication buses or signal lines.

Sensors, devices, and subsystems may be coupled to peripherals interface 612 to facilitate one or more functionalities. For example, a motion sensor 616, a light sensor 620, and a proximity sensor 624 may be coupled to peripherals interface 612 to facilitate orientation, lighting, and/or proximity functions. Other sensors 628 may also be connected to peripherals interface 612, such as a global navigation satellite system (GNSS) (e.g., GPS receiver), a temperature sensor, a biometric sensor, and/or one or more other sensing devices, to facilitate related functionalities.

A camera subsystem 632 and an optical sensor 636 (e.g., a charged coupled device (CCD) or a complementary metal-oxide semiconductor (CMOS) optical sensor) may be utilized to facilitate camera functions, such as recording images and/or video. Camera subsystem 632 and optical sensor 636 may be used to collect images of a user to be used during authentication of a user (e.g., by performing facial recognition analysis). In some embodiments, the camera subsystem 632 and/or optical sensor 636 may be omitted.

Communication functions may be facilitated through one or more wireless communication subsystems 640, which may include radio frequency receivers and transmitters and/or optical (e.g., infrared) receivers and transmitters. The specific design and implementation of communication subsystem 640 may depend on the communication network(s) over which computing device 600 is intended to operate. For example, the computing device 600 may include communication subsystems 640 designed to operate over a GSM network, a GPRS network, an EDGE network, a Wi-Fi™ or WiMax™ network, and/or a Bluetooth™ network. In particular, the wireless communication subsystems 640 may include hosting protocols such that one or more devices 600 may be configured as a base station for other wireless devices.

An audio subsystem 644 may be coupled to a speaker 648 and a microphone 652 to facilitate voice-enabled functions, such as speaker recognition, voice replication, digital recording, and/or telephony functions. The audio subsystem 644 may be configured to facilitate processing voice commands, voice-printing, and voice authentication.

I/O subsystem 656 may include a touch-surface controller 660 and/or other input controller(s) 664. Touch-surface controller 660 may be coupled to a touch surface 668. The touch surface 668 and touch-surface controller 660 may, for example, detect contact and movement or a lack thereof using one or more of any of a plurality of touch sensitivity technologies, including but not limited to capacitive, resistive, infrared, and/or surface acoustic wave technologies, optionally as well as other proximity sensor arrays and/or other elements for determining one or more points of contact with touch surface 668.

Other input controller(s) 664 may be coupled to other input/control devices 672, such as one or more buttons, rocker switches, dials, thumb-wheel, infrared port, USB port, and/or a pointer device such as a stylus. One or more related buttons or other controls (not shown) may include one or more sets of up/down buttons for volume and/or amplitude control of speaker 648 and/or microphone 652. Using the same or similar buttons or other controls, a user may activate a voice control, or voice command, module that enables the user to speak commands into microphone to cause the device 600 to execute the spoken command. The user may customize functionality of one or more buttons or other controls. The touch surface 668 may, for example, also be used to implement virtual or soft buttons and/or a keyboard.

In some implementations, the computing device 600 may present recorded audio and/or video files, such as MP3, AAC, and/or MPEG files. In some implementations, the computing device 600 may include the functionality of an MP3 player, such as an iPod™. The computing device 600 may, therefore, include a 36-pin connector that is compatible with related iPod™ hardware. Other input/output and control devices may also be used.

As shown, memory interface 604 may be coupled to one or more types of memory 676. Memory 676 may include high-speed random access memory and/or non-volatile memory, such as one or more magnetic disk storage devices, one or more optical storage devices, and/or flash memory (e.g., NAND, NOR). Memory 676 may store an operating system 680, such as Darwin™ RTXC, LINUX, UNIX, OS X™, WINDOWS™, and/or an embedded operating system such as VxWorks. Operating system 680 may include instructions for handling basic system services and/or for performing hardware dependent tasks. In some implementations, the operating system 680 may comprise a kernel (e.g., UNIX kernel). Further, in some implementations, the operating system 680 may include instructions for performing voice authentication.

Memory 676 may also store communication instructions 682 to facilitate communicating with one or more additional devices, one or more computers, and/or one or more servers. Additionally or alternatively, memory 676 may include: graphical user interface instructions 684 to facilitate graphic user interface processing; sensor processing instructions 686 to facilitate sensor-related processing and functions; phone instructions 688 to facilitate phone-related processes and functions; electronic messaging instructions 690 to facilitate electronic-messaging related processes and functions; web browsing instructions 692 to facilitate web browsing-related processes and functions; media processing instructions 694 to facilitate media processing-related processes and functions; GNSS/Navigation instructions 696 to facilitate GNSS and navigation-related processes and instructions; and/or camera instructions 697 to facilitate camera-related processes and functions. Memory 676 may store other software instructions 698 to facilitate other processes and functions. For example, other software instructions 698 may include pedometer instructions for counting steps the user takes when device 600 is worn.

Memory 676 may also store other software instructions (not shown), such as web video instructions to facilitate web video-related processes and functions and/or web shopping instructions to facilitate web shopping-related processes and functions. In some implementations, media processing instructions 694 may be divided into audio processing instructions and video processing instructions to facilitate audio processing-related processes and functions and video processing-related processes and functions, respectively. An activation record and International Mobile Equipment Identity (IMEI) 699 or similar hardware identifier may also be stored in memory 676.

Each of the above identified instructions and applications may correspond to a set of executable instructions for performing one or more functions described herein. These instructions need not necessarily be implemented as separate software programs, procedures, or modules. Memory 676 may include additional instructions or fewer instructions. Further, various functions of computing device 600 may be implemented in hardware and/or in software, including in one or more signal processing and/or application specific integrated circuits.

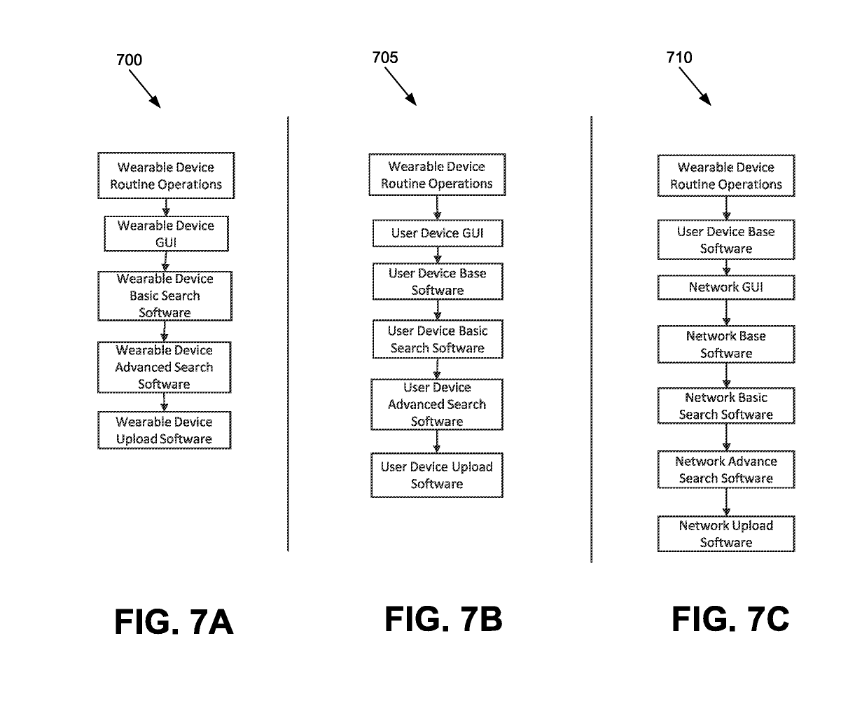

FIGS. 7A, 7B, and 7C shows example methods 700, 705, 710, respectively, that may be executed by one or more devices of the system 200 of FIG. 2. As shown, starting with method 700 of FIG. 7A, which wearable device base software 212 may be configured to perform, the method 700 may begin with wearable device routine operations (e.g., collecting sensor data, executing any data analysis, and reporting the data). The method 700 may then proceed to display wearable device GUI 226, then wearable device basic search software 214, then wearable device advanced search software 218, and then wearable device upload software 216. Turning now to method 705 of FIG. 7B, which user device base software 248 may be configured to perform, this method 705 may begin with wearable device routine operations, as described above, and then may proceed to displaying user device GUI 260, user device base software 248, user device basic search software 254, user device advanced search software 256, and user device upload software 258. Turning now to method 710 of FIG. 7C, which search network base software 268 may be configured to perform, this method may begin with the wearable device routine operations, and then run user device base software 248, network GUI 278, network base software 268, network basic search software 270, network advanced search software 274, and network upload software 272. Because the implementation of particulars of the present disclosure depends on where the data from the wearable device is stored, different ones of the methods shown in FIGS. 7A-7C may be used under different circumstances. For example, if the data is stored on wearable device 202, then the user may choose method 700, which may be executed by the wearable device base software 212. If the data is actually stored on the user device 204, then the user may choose method 705, which may be executed by the user device base software 248. If the data is stored in search network device 206, then the user may choose method 710, which may be executed by search network base software 268. In some embodiments, each individual base software shown in FIGS. 7A-7C may be in communication with each other such that a user can run any one of the programs and system 200 identifies where the data is stored and execute one or more appropriate processes in order to use the appropriate search software.

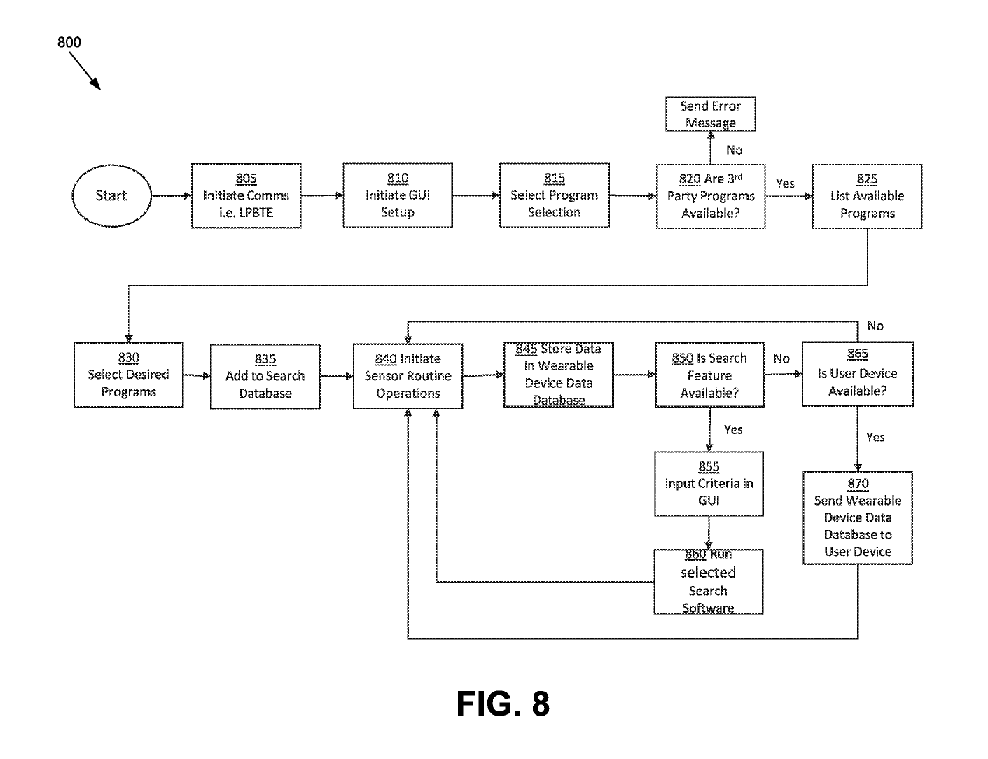

FIG. 8 shows an example method 800 that the wearable device base software 212 may be configured to perform. In this example, the method 800 may be implemented when the wearable device data is stored on wearable device 202. The method 800 may begin by initiating communications at step 805, such as, for example, low power Bluetooth™. The method 800 may then initiate the GUI setup at step 810, enable program selection at step 815, identify whether one or more third party programs 284 are available at step 820, and, if not, then the method 800 may send an error message. However, if third party programs 284 are available, the method 800 may list the available programs at step 825. Then the user may select the desired programs at step 830, after which the method 800 may add the programs to the search database at step 835 and initiate sensor routine operations at step 840. The method 800 may then store resulting sensor data in wearable device data database 220 at step 845 and determine whether the search feature is available at step 850. If so, then the user may input criteria in the GUI at step 855 and the method 800 runs the selected search software at step 860, after which the method may return to step 840 to initiate sensor routine operations. However, if the search feature is not available, then method 800 may proceed to step 865 and determine whether user device 204 is available. If user device 204 is not available, then the method 800 may return to step 840 and initiate sensor routine operations. However, if the user device 204 is available, then the method 800 may cause wearable device 202 to send wearable device data database 220 to the user device at step 870, after which the method may return to step 840 to initiate sensor routine operations.

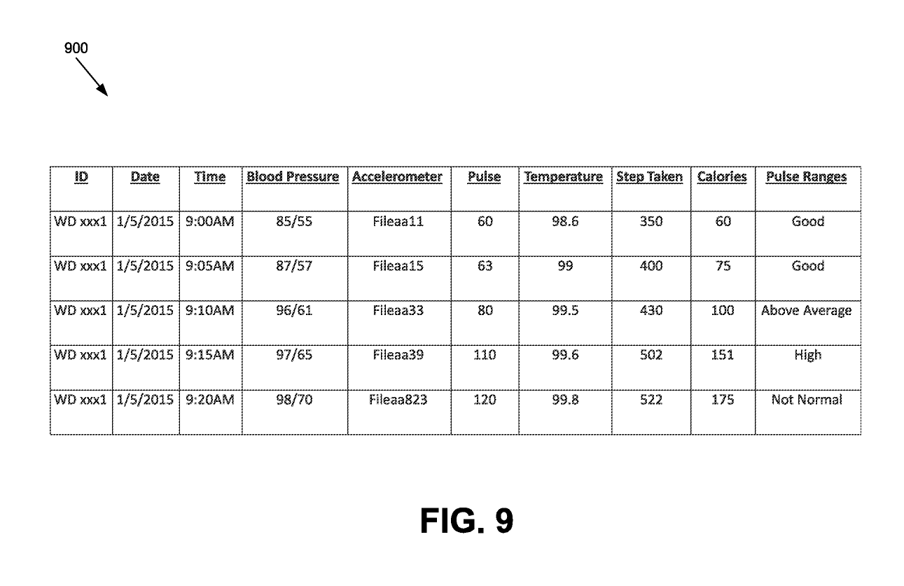

FIG. 9 shows an example of an embodiment of a wearable device data database 900. As shown, such a database 900 may include one or more wearable device IDs, dates, times, and a number of associated sensor readings. In some embodiments, additional information may include tags and/or comments. For the purposes of this example, the sensor readings shown in FIG. 9 correspond to blood pressure, accelerometer, pulse, temperature, steps taken, calories, and pulse ranges. Notably, the accelerometer data may be saved into one or more files, the number of steps taken between each sensor reading can be determined and used as a datum, and the calories burned in that time period can be estimated from the number of steps. Further, a qualitative assessment of the user's pulse range can be generated at each sensor reading. Note that some embodiments of a wearable device data database may have fewer types of entries, additional types of entries, and/or different types of entries in some embodiments.

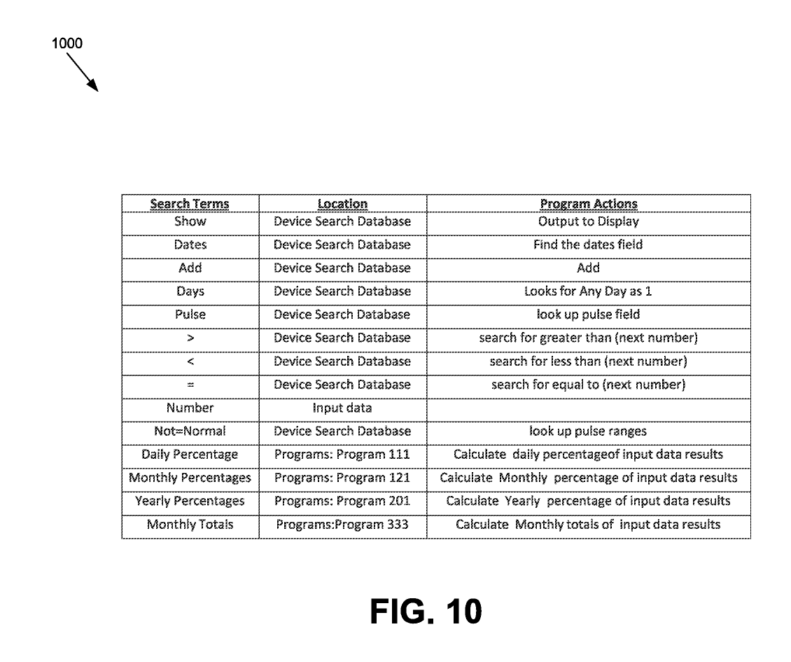

FIG. 10 shows an example of an embodiment of a search database 1000 that may be stored in the wearable device 202, the user device 204, and/or the search network device 206. The different search terms, e.g., “show,” “dates,” “add,” “days,” “pulse,” etc., enable searches to be parsed to provide relevant search results. After a search identifies a term then it can identify an appropriate program location and action. For example, “show” may be located in the device search database and the corresponding program action may be to output to display. For “dates,” the program action may be to find the dates field. For “add,” the program action may simply be to add. For “days,” the program action may be to look for any day as one and then, based on other search terms, the search may identify a number as input data, which allows the search to parse the search appropriately and provide relevant search results.

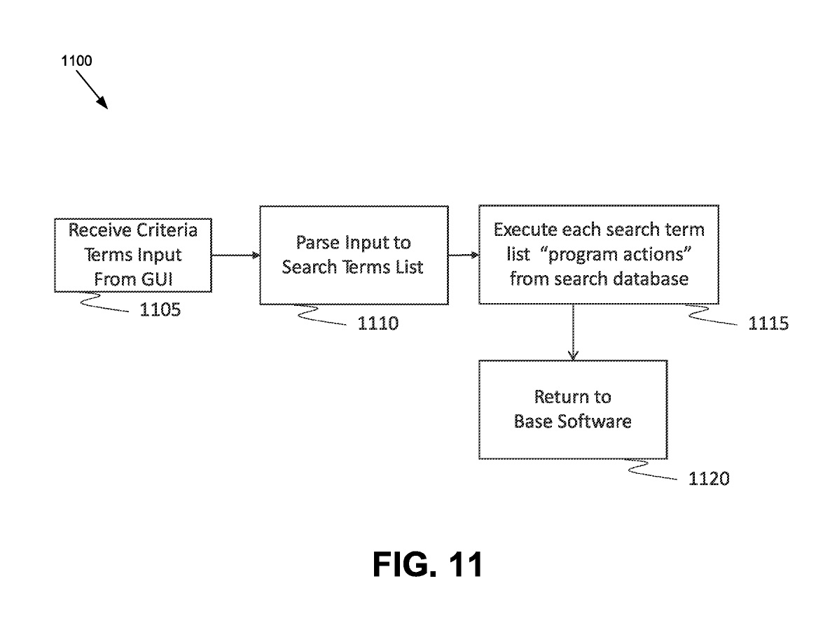

FIG. 11 shows an example method 1100 that selected search software may be configured to perform and that may be stored on the wearable device 202, the user device 204, and/or the search network device 206. As shown, the method 1100 may begin with step 1105 by receiving criteria terms input from a GUI and then, at step 1110, parse the input to a search terms list. The method 1100 may then execute corresponding search term list program actions in a search database at step 1115 and return to base software at step 1120.

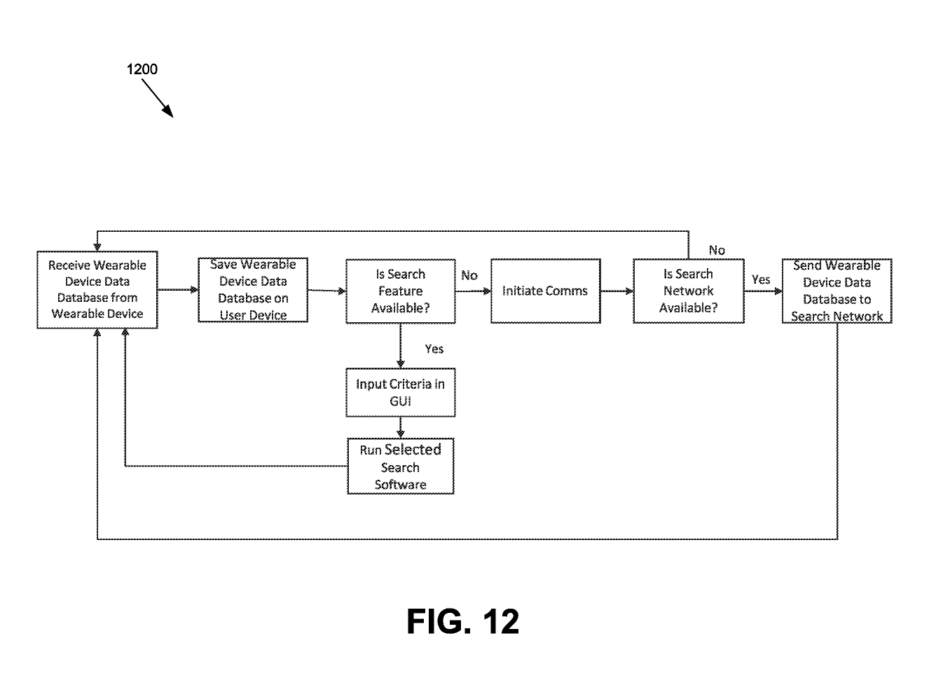

FIG. 12 shows an example method 1200 that the user device base software 248 may be configured to perform when the wearable device data is stored on the user device 204. In this example, the method 1200 begins by receiving the wearable device data database 220 from the wearable device 202. The method 1200 may then save the wearable device data database 220 on the user device 204 and determine whether a search feature is available. If yes, then the user may input the criteria in the GUI, the method 1200 may run the selected search software, and then the method 1200 may return to receiving the wearable device data database 220 from the wearable device 202. However, if the search feature is not available, then the user device 204 may initiate the communication interface 242 and determine whether the search network device 206 is available. If not, then the method 1200 may return to receiving the wearable device data database 220 from the wearable device 202. However, if the search network device 206 is available, then the user device 204 may send the wearable device data database 262 to the search network device 206 and return to receiving the wearable device data database 220 from the wearable device 202.

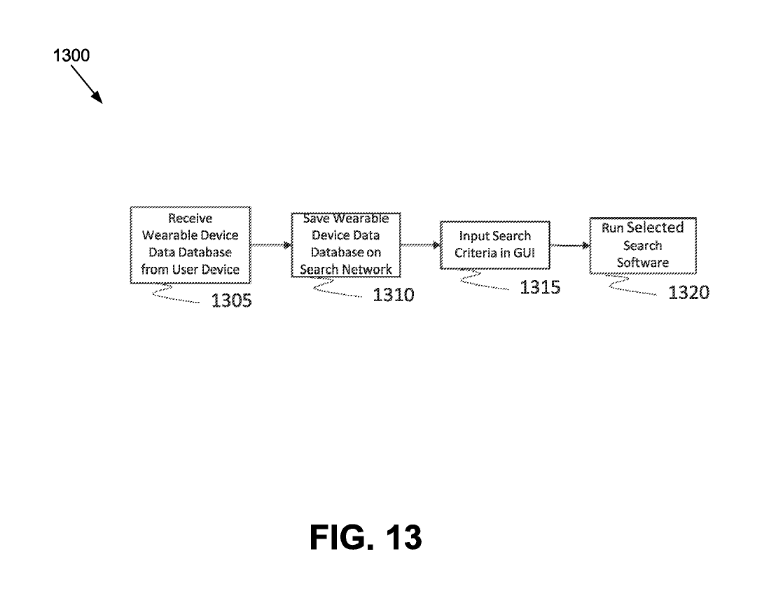

FIG. 13 shows an example method 1300 that the search network base software 268 may be configured to perform when the wearable device data is stored in the search network device 206 and/or one or more devices on the cloud 208. In this example, the method 1300 begins at step 1305 by receiving the wearable device data database 262 from the user device 204. The method 1300 may then save the wearable device data database 262 on the search network device 206 at step 1310. A user may then provide search criteria in the GUI at step 1315, after which the search network device 206 may receive the search criteria and run the selected search software at step 1320.

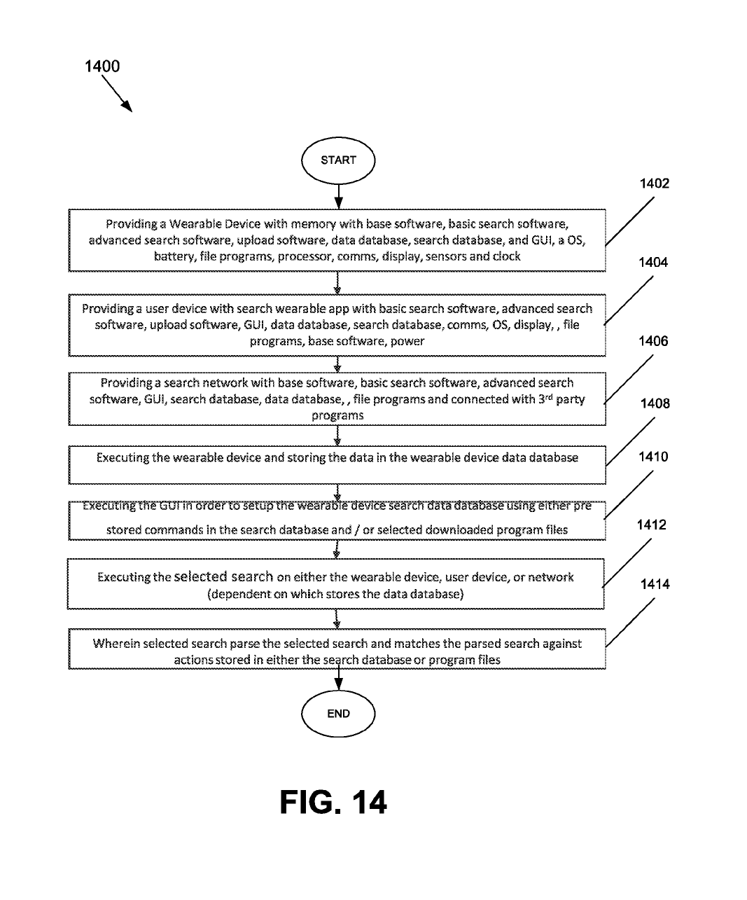

FIG. 14 shows an example of a particular method 1400 that can be used to implement the wearable devices with searchable data. Such a method 1400 may begin with providing a wearable device with memory with base software, basic search software, advanced search software, upload software, a data database, a search database, a GUI, an OS, a battery or other power source, file programs, a processor, a communication interface, a display, one or more sensors, and a clock (1402). Next, the method 1400 may involve providing a user device with a search wearable app with basic search software, advanced search software, upload software, a GUI, a data database, a search database, a communication interface, an OS, a display, file programs, base software, and a power source (1404). Next, the method 1400 may involve providing a search network with base software, basic search software, advanced search software, a GUI, a search database, a data database, file programs, and one or more associated third party programs (1406). The method 1400 may then involve executing one or more functions of the wearable device, storing any resulting data in the wearable device data database (1408), and executing the GUI in order to set up the wearable device search data database using either pre-stored commands in the search database and/or selected downloaded program files (1410). The method 1400 may then involve executing the selected search on either the wearable device, the user device, or the search network, depending on which stores the data database (1412). Next, the method 1400 may involve a selected search parsing the search terms and matching the terms against actions stored in either the search database or program files (1414).

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions (executable code) of the software and/or software module.

Such software may be a computer program product that employs a non-transitory machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, wearable device, etc.), a web appliance, a network router, a network switch, a network bridge, any machine capable of executing a sequence of instructions that specify an action to be taken by that machine, and any combinations thereof. In one example, a computing device may include and/or be included in a kiosk.

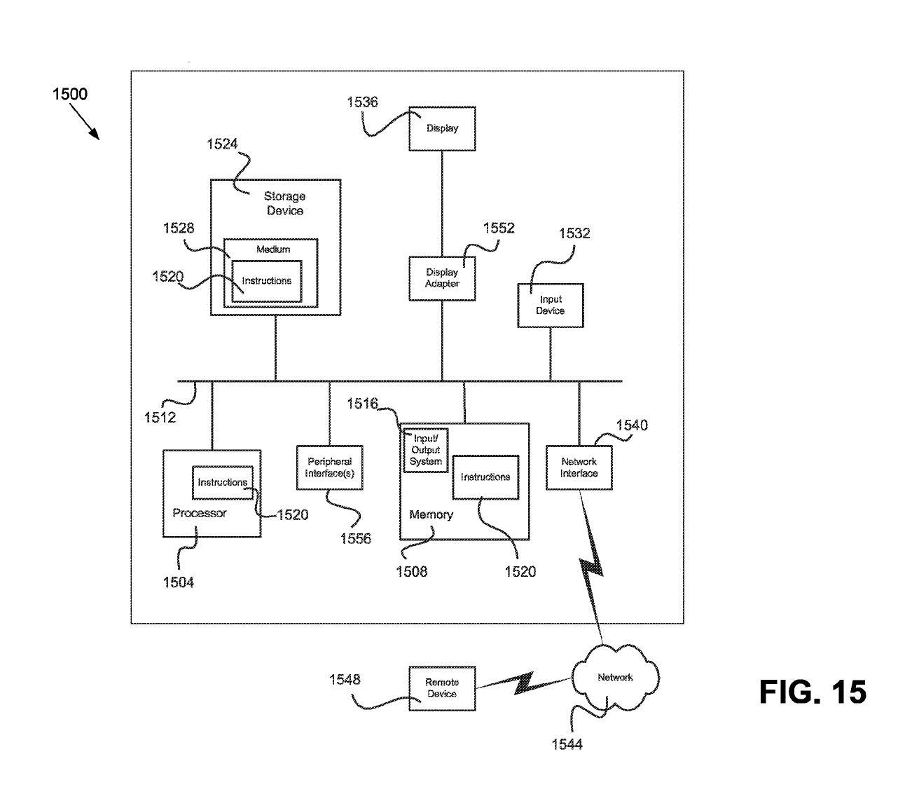

FIG. 15 shows a diagrammatic representation of one embodiment of a computing device in the example form of a computer system 1500 within which a set of instructions for causing a control system, such as any one or more of various systems of the present disclosure, such as the systems illustrated in other figures of this disclosure, as well as systems that would be apparent to those of ordinary skill in the art after reading this entire disclosure, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. The computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Memory 1508 may include various components (e.g., machine-readable media) including, but not limited to, a random access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

The computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. The storage device 1524 may be connected to the bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, the storage device 1524 (or one or more components thereof) may be removably interfaced with computer system 1500 (e.g., via an external port connector (not shown)). Particularly, the storage device 1524 and an associated machine-readable medium 1528 may provide nonvolatile and/or volatile storage of machine-readable instructions, data structures, program modules, and/or other data for the computer system 1500. In one example, software 1520 may reside, completely or partially, within machine-readable medium 1528. In another example, software 1520 may reside, completely or partially, within the processor 1504.

The computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. The input device 1532 may include a touch screen interface that may be a part of or separate from display device 1536, discussed further below. The input device 1532 may be utilized as a user selection device for selecting one or more graphical representations in a graphical interface as described above.

A user may also input commands and/or other information to the computer system 1500 via the storage device 1524 (e.g., a removable disk drive, a flash drive, etc.) and/or the network interface device 1540. A network interface device, such as the network interface device 1540, may be utilized for connecting the computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as the network 1544, may employ a wired and/or a wireless mode of communication. In general, any network topology may be used. Information (e.g., data, software 1520, etc.) may be communicated to and/or from the computer system 1500 via the network interface device 1540.

The computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. The display adapter 1552 and the display device 1536 may be utilized in combination with the processor 1504 to provide graphical representations of aspects of the present disclosure. In addition to a display device, the computer system 1500 may include one or more other peripheral output devices including, but not limited to, an audio speaker, a printer, and any combinations thereof. Such peripheral output devices may be connected to the bus 1512 via a peripheral interface 1556. Examples of a peripheral interface include, but are not limited to, a serial port, a USB connection, a FIREWIRE connection, a parallel connection, and any combinations thereof.

In one embodiment, a first independent claim directed to an apparatus is disclosed, comprising: a memory comprising a wearable device data database, the wearable device data database comprising data associated with wearable sensors for a user; a user interface configured to receive user input; and a processor configured to: receive signals corresponding to plural search terms entered at the user interface according to the user input, the plural search terms created by the user at the time of entry and comprising a first term associated with the data and one or more second terms associated with a context for the data; execute a search of the wearable device data database based on the received signals to produce search results; and provide the search results to the user, the search results customized according to the entered context. The apparatus of the first independent claim, wherein the first term comprises a physiological parameter associated with the data. The apparatus of the prior claim, wherein the physiological parameter comprises any one of the following: blood pressure, accelerometer information, pulse, temperature, steps taken, or calories. The apparatus of the first independent claim, wherein the user interface comprises one or any combination of the following: a display screen, a microphone, a keyboard, or buttons. The apparatus of the first independent claim, wherein the one or more second terms comprise one or any combination of a comment, tag, or a metric, associating user activity or behavior and the data. The apparatus of the prior claim, wherein the metric comprises any one of the following: daily percentages, monthly percentages, yearly percentages, daily totals, monthly totals, or yearly totals. In one embodiment, the metric comprises a comparison of the user activity or behavior for the user relative to a datum. The apparatus of the first independent claim, wherein the processor is further configured to execute the search by parsing the plural search terms and identifying one or more associated programs based on the parsing. The apparatus of the first independent claim, wherein the processor is further configured to execute the search by parsing search terms to identify one or more data structures of the wearable device data database. The apparatus of the first independent claim, wherein the processor is configured to provide the search results by visually or aurally presenting the search results at a wearable device. The apparatus of the first independent claim, wherein the processor is configured to present the search results visually or aurally exclusive of information corresponding to wearable device data that is not based on the plural search terms. The apparatus of the first independent claim, wherein the processor is configured to provide the search results by transmitting the search results to the user in a text message, an e-mail, or a combination of the text message and the e-mail. The apparatus of the first independent claim, wherein the apparatus comprises a wearable device comprising the wearable sensors. The apparatus of the first independent claim, wherein the apparatus comprises a user device that is in wireless communication with a wearable device that comprises the wearable sensors. The apparatus of the first independent claim, wherein the apparatus comprises a network device that is remote from a wearable device that comprises the wearable sensors.

In one embodiment, a second independent claim directed to a non-transitory, machine-readable storage medium is disclosed, the non-transitory, machine-readable storage medium encoded with instructions that, when executed by one or more processors, cause the one or more processors to: receive signals corresponding to plural search terms entered at a user interface according to user input, the plural search terms created by the user at the time of entry and comprising a first term associated with data of a wearable device data database that is associated with wearable sensors for a user and one or more second terms associated with a context for the data; execute a search of the wearable device data database based on the received signals to produce search results; and provide the search results to the user, the search results customized according to the entered context. The non-transitory machine-readable storage medium of the second independent claim, wherein the first term comprises a physiological parameter associated with the data, the physiological parameter comprising any one of the following: blood pressure, accelerometer information, pulse, temperature, steps taken, or calories, and the one or more second terms comprise one or any combination of a comment, tag, or metric, associating user activity or behavior and the data, the metric comprising any one of the following: daily percentages, monthly percentages, yearly percentages, daily totals, monthly totals, yearly totals. The non-transitory machine-readable storage medium of the second independent claim, further comprising instructions that, when executed by the one or more processors, cause the one or more processors to visually provide the search results at a wearable device comprising the wearable sensors. The non-transitory machine-readable storage medium of the second independent claim, further comprising instructions that, when executed by the one or more processors, cause the one or more processors to visually or aurally provide the search results at a wearable device comprising the wearable sensors, wherein the search results are presented visually or aurally exclusive of information corresponding to wearable device data that is not based on the plural search terms.

In one embodiment, a third independent claim directed to a method is disclosed, comprising receiving signals corresponding to plural search terms entered at a user interface according to user input, the plural search terms created by the user at the time of entry and comprising a first term associated with data of a wearable device data database that is associated with wearable sensors for a user and one or more second terms associated with a context for the data; executing a search of the wearable device data database based on the received signals to produce search results; and providing the search results to the user, the search results customized according to the entered context.

The foregoing has been a detailed description of illustrative embodiments of the invention. Various modifications and additions can be made without departing from the spirit and scope of this invention. For instance, although described in the context of searching a wearable device data database, wherein the data is sourced or derived from wearable sensors, in some embodiments, the data (and/or database) may be sourced or derived from other devices in addition to, or in lieu of, the data sourced or derived from the wearable sensors. Examples of such non-wearable devices include weight scales, blood pressure monitors, smart home devices (e.g., smart thermostats, smart refrigerators, smart doors), Internet of Things (IOT) devices, whether for home or business/recreational use, among other devices that enable an overview, or detailed, assessment of a user's personal health and/or behavior. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve various aspects of the present disclosure. Accordingly, this description is meant to be taken only by way of example, and not to otherwise limit the scope of this invention.

Example embodiments have been disclosed above and illustrated in the accompanying drawings. It will be understood by those skilled in the art that various changes, omissions and additions may be made to that which is specifically disclosed herein without departing from the spirit and scope of the present invention. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical medium or solid-state medium supplied together with or as part of other hardware, but may also be distributed in other forms.

1. A wearable device, comprising:
a plurality of sensors, wherein at least one of the sensors is configured to measure a physiological parameter of a user, the plurality of sensors providing one or more sensor signals comprising sensor data;
a memory comprising a wearable device data database, the wearable device data database comprising the sensor data and context data associated with the sensor data;
a user interface configured to receive user input; and
a processor configured to:
receive signals corresponding to plural search terms entered at the user interface according to the user input, the plural search terms created by the user at the time of entry and comprising a first term and one or more second terms, the first term comprising a physiological or behavioral parameter and the one or more second terms comprising a context;
execute a search of the wearable device data database based on the received signals to produce search results; and
provide the search results to the user, the search results customized according to the entered context and based on correspondence between the first term and the sensor data and correspondence between the one or more second terms and the context data.

2. The wearable device of claim 1, wherein the sensor data comprises raw sensor data.

3. The wearable device of claim 1, wherein the physiological parameter comprises any one of the following: blood pressure, accelerometer information, pulse, temperature, steps taken, or calories.

4. The wearable device of claim 1, wherein the user interface comprises one or any combination of the following: a display screen, a microphone, a keyboard, or buttons.

5. The wearable device of claim 1, wherein the one or more second terms comprise one or any combination of a comment, tag, or a metric, associating user activity or behavior and the sensor data.

6. The wearable device of claim 5, wherein the metric comprises any one of the following: daily percentages, monthly percentages, yearly percentages, daily totals, monthly totals, or yearly totals.

7. The wearable device of claim 6, wherein the metric comprises a comparison of the user activity or behavior for the user relative to a datum.

8. The wearable device of claim 1, wherein the processor is further configured to execute the search by parsing the plural search terms and identifying one or more associated programs based on the parsing.

9. The wearable device of claim 1, wherein the processor is further configured to execute the search by parsing search terms to identify one or more data structures of the wearable device data database.

10. The wearable device of claim 1, wherein the processor is configured to provide the search results by visually or aurally presenting the search results at the wearable device.

11. The wearable device of claim 1, wherein the processor is configured to present the search results visually or aurally exclusive of information corresponding to wearable device data that is not based on the plural search terms.

12. The wearable device of claim 1, wherein the processor is configured to provide the search results by transmitting the search results to the user in a text message, an e-mail, or a combination of the text message and the e-mail.

13. The wearable device of claim 1, wherein the wearable device is a wrist-worn device.

14. The wearable device of claim 1, wherein the processor is further configured to communicate the data structure and the plural search terms to a user device that is in wireless communication with the wearable device.

15. (canceled)

16. A non-transitory, machine-readable storage medium encoded with instructions that, when executed by one or more processors, cause the one or more processors to:
receive one or more sensor signals comprising sensor data, at least one of the sensor data comprising a measure of a physiological parameter of a user;
store in a wearable device data database the sensor data and context data associated with the sensor data;
receive signals corresponding to plural search terms entered at a user interface according to user input, the plural search terms created by the user at the time of entry and comprising a first term and one or more second terms, the first term comprising a physiological or behavioral parameter and the one or more second terms comprising a context;
execute a search of the wearable device data database based on the received signals to produce search results; and
provide the search results to the user, the search results customized according to the entered context and based on correspondence between the first term and the sensor data and correspondence between the one or more second terms and the context data.

17. The non-transitory machine-readable storage medium of claim 17, wherein the physiological parameter comprises any one of the following: blood pressure, accelerometer information, pulse, temperature, steps taken, or calories, and the one or more second terms comprise one or any combination of a comment, tag, or metric, associating user activity or behavior and the data, the metric comprising any one of the following: daily percentages, monthly percentages, yearly percentages, daily totals, monthly totals, yearly totals.

18. The non-transitory machine-readable storage medium of claim 17, further comprising instructions that, when executed by the one or more processors, cause the one or more processors to visually provide the search results at a wearable device, a user device, or a network device.

19. The non-transitory machine-readable storage medium of claim 17, further comprising instructions that, when executed by the one or more processors, cause the one or more processors to visually or aurally provide the search results visually or aurally exclusive of information corresponding to wearable device data that is not based on the plural search terms.

20. A method comprising:
receiving one or more sensor signals comprising sensor data, at least one of the sensor data comprising a measure of a physiological parameter of a user;
storing in a wearable device data database the sensor data and context data associated with the sensor data;
receiving signals corresponding to plural search terms entered at a user interface according to user input, the plural search terms created by the user at the time of entry and comprising a first term and one or more second terms, the first term comprising a physiological or behavioral parameter and the one or more second terms comprising a context;
executing a search of the wearable device data database based on the received signals to produce search results; and
providing the search results to the user, the search results customized according to the entered context and based on correspondence between the first term and the sensor data and correspondence between the one or more second terms and the context data.
